(19) United States
(12) Patent Application Publication
(10) Pub. No.: US 2026/0066576 A1
(43) Pub. Date: Mar. 5, 2026

(54) ELECTRICAL CONNECTOR SYSTEMS HAVING CONNECTOR COMPONENTS AND REMOVABLE HEAT SINK MODULES

(71) Applicant: Lenovo Global Technology (United States) Inc., Morrisville, NC (US)

(72) Inventors: Jerry Ackaret, Morrisville, NC (US); Paul Klustaitis, Morrisville, NC (US); James C. Loebach, Morrisville, NC (US); Ananthakrishnan Narayanan, Morrisville, NC (US); Brian Christopher Totten, Morrisville, NC (US); Robert R. Wolford, Morrisville, NC (US)

(21) Appl. No.: 18/820,027

(22) Filed: Aug. 29, 2024

(51) Int. Cl. H01R 13/533

(52) U.S. Cl. CPC H01R 13/533

(57) ABSTRACT

Electrical connector systems having connector components and removable heat sink modules are disclosed. According to an aspect, an electrical connector system includes a first connector component that is electrically conductive and that includes a first conductive interface. The electrical connector system also includes a second connector component that is electrically conductive and that includes a second conductive interface. The first and second conductive interfaces are configured to operatively connect to each other. Further, the electrical connector system includes a heat sink module configured to removably attach to the second connector component and configured to transfer heat energy away from the second connector component.

### TECHNICAL FIELD

The presently disclosed subject matter relates generally to electrical connectors. Particularly, the presently disclosed subject matter relates to electrical connector systems having connector components and removable heat sink modules.

### BACKGROUND

Electrical connectors are utilized to join electrical circuits together for power distribution or data communication. Electrical connectors come in a variety of forms to ensure reliable connection and to facilitate assembly and disassembly (e.g., connection and disconnection of the electrical circuits). In addition, electrical connectors must meet requirements such as current and voltage ratings.

In some use cases, electrical connectors must conduct high levels of current. This is becoming increasingly common in computing hardware as energy consumption density increases. Electrical connectors delivering high current are often limited in capability by self-heating temperature rise, which is a consequence of high current power delivery. To maintain a safe operating temperature, designers are often driven to use more or larger connectors, limit product energy utilization, or develop expensive custom connector solutions. Also, some operating environments have very limited space available for electrical connectors. In view of these difficulties, there is a need to provide electrical connectors that can safely conduct high levels of current while also being adaptable to given operating space constraints.

### SUMMARY

The presently disclosed subject matter relates to electrical connector systems having connector components and removable heat sink modules. According to an aspect, an electrical connector system includes a first connector component that is electrically conductive and that includes a first conductive interface. The electrical connector system also includes a second connector component that is electrically conductive and that includes a second conductive interface. The first and second conductive interfaces are configured to operatively connect to each other. Further, the electrical connector system includes a heat sink module configured to removably attach to the second connector component and configured to transfer heat energy away from the second connector component.

According to another aspect, an electrical connector system includes a first connector component that is electrically conductive and that includes a first conductive interface on a first surface of the first connector component and a first heat sink attachment aperture on a second surface of the first connector component. Further, the electrical connector system includes a second connector component that is electrically conductive and that includes a second conductive interface on a first surface of the second connector component and a second heat sink attachment aperture on a second surface of the second connector component. The first and second conductive interfaces are configured to operatively connect to each other. A heat sink module is configured to removably attach to either the first connector component via the first heat sink attachment aperture or the second connector component via the second heat sink attachment aperture and configured to transfer heat energy away from the attached first or second connector component.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a perspective view of an electrical connector system including connector components and an attachable heat sink module in accordance with embodiments of the present disclosure;

FIG. 2 is a perspective view of the heat sink module attached to connector component and the connector components being spaced apart;

FIG. 3 is a perspective view of connector component and the heat sink module operably attached together in accordance with embodiments of the present disclosure;

FIG. 4 is a perspective view of the attachment of the heat sink module to a different connector component than the connector component shown in FIG. 1;

FIG. 5 is a perspective view of the heat sink module and screw being spaced apart;

FIGS. 6A and 6B are respectively a front view and a side view of the heat sink module in accordance with embodiments of the present disclosure;

FIG. 7 is a perspective view of the electrical connector system with the heat sink module oriented differently than its orientation in FIG. 4; and

FIG. 8 is a side view of another electrical connector system in accordance with embodiments of the present disclosure.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting”of those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

As referred to herein, the term “electrical connector” or “electrical connector system” can be used interchangeably and generally relate to a device or one or more components that operably connect electrical circuits or other electrical components together. For example, the electrical circuit or other electrical components can be connected together for power distribution or data communication. The electrical connector can be used to electrically connect the electrical circuit or components for passing electrical current therebetween. As a result, the electrical circuit or components can be operably joined together as a larger circuit or system. Electrical connectors can be considered a physical interface and operate as part of the physical layer in an Open Systems Interconnection (OSI) model of networking. In an example, an electrical connector can be used for operably connecting a printed circuit board (PCB) or a component thereon to another electrical circuit. In another example, an electrical connector can be used for operably connecting expansion module to a computing device, such as a server, desktop, or laptop computer

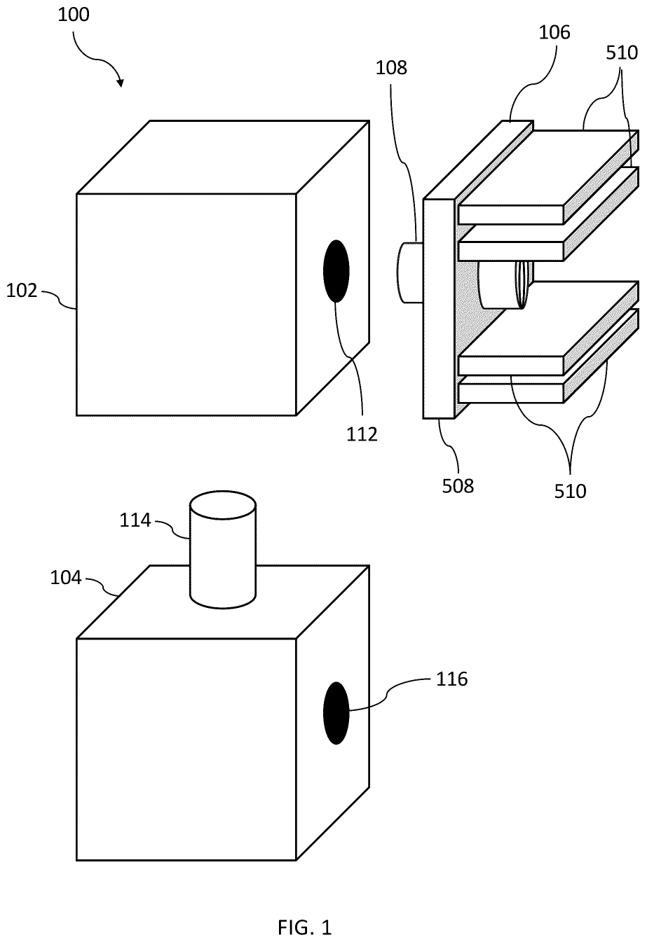

FIG. 1 illustrates a perspective view of an electrical connector system 100 including connector components 102 and 104 and an attachable heat sink module 106 in accordance with embodiments of the present disclosure. Generally, the electrical connector system 100 can be suitably utilized for providing a conductive pathway between two points. For example, the electrical connector system 100 can be used to join electrical circuits together for power distribution or data communication.

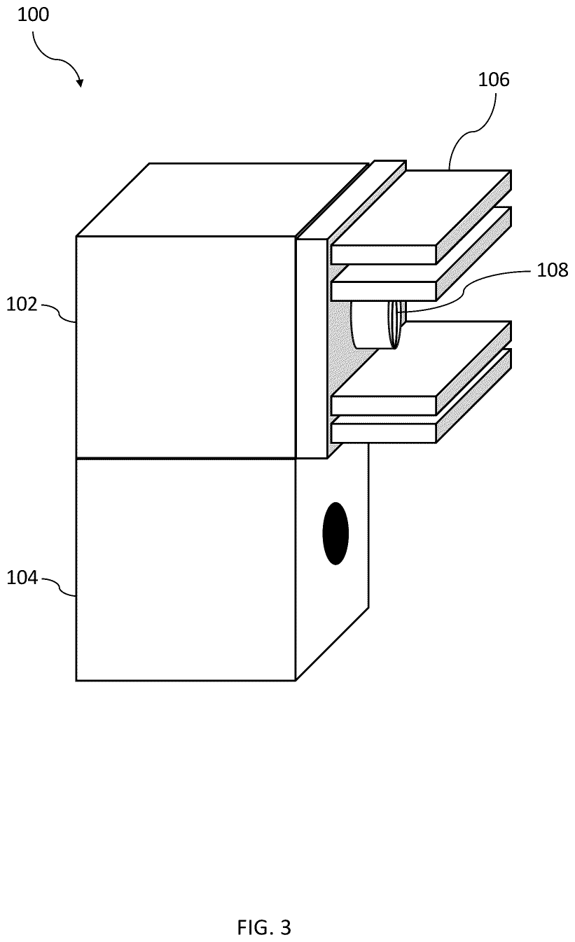

Referring to FIG. 1, connector components 102 and 104 are shown as being spaced apart, but in operation they can be operably connected together (as shown in FIG. 3) for providing a conductive pathway between connector components 102 and 104. As a result for example, circuitry attached to connector component 102 can be operably connected to circuitry attached to connector component 104. Connector components 102 and 104 may be suitably attached to their respective circuitry via any suitable mechanism such as a wire, solder, plug-and-socket connection, or the like.

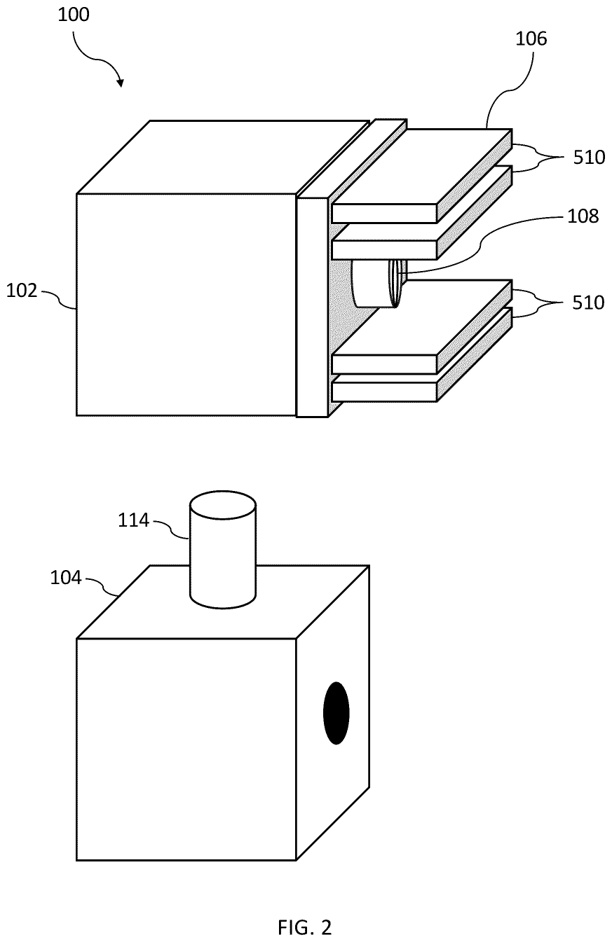

With continuing reference to FIG. 1, the electrical connector system 100 is shown in a disassembled state. As described in more detail herein, an installer can assemble connector components 102 and 104 and the heat sink module 106 together when connecting different electrical circuitry attached to respective connector component 102 and 104. Initially, the heat sink module 106 can be attached to connector component 102. FIG. 2 illustrates a perspective view of the heat sink module 106 attached to connector component 102 and the connector components 102 and 104 being spaced apart.

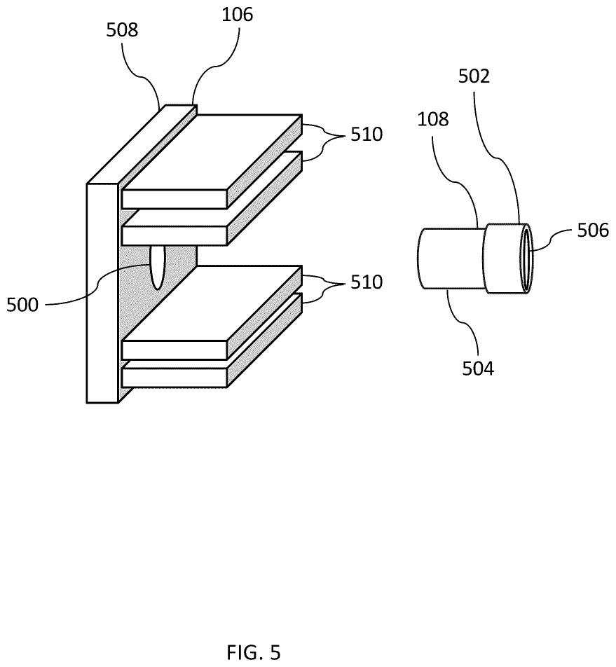

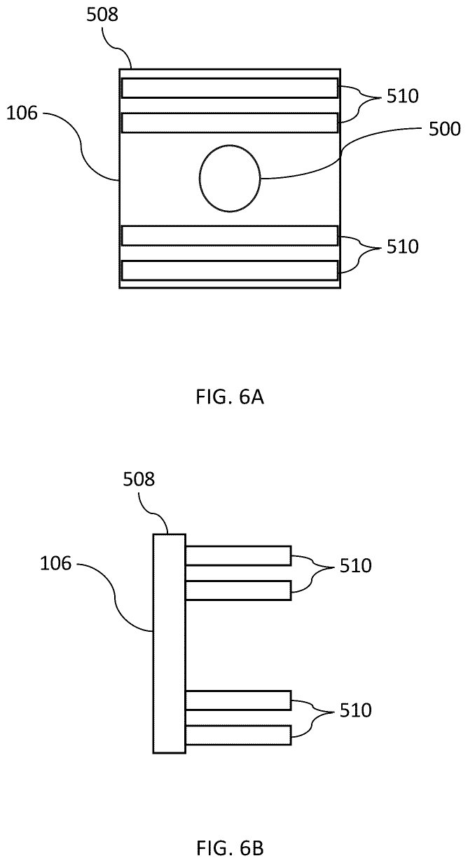

The heat sink module 106 can be attached to connector component 102 via any suitable technique or mechanism. In this example, a screw 108 can be inserted through an aperture (shown in FIGS. 5 and 6A and indicated with reference number 500) of the heat sink module 106 and subsequently screwed into a threaded hole (or heat sink attachment aperture) 112 within the connector component 102 for securing the heat sink module 106 to the connector component 102. In this example, surfaces of the heat sink module 106 and the connector component 102 touch and/or are in thermal contact with one another for facilitating conductive heat transfer between the heat sink module 106 and the connector component 102.

Alternative to a screw, in one example a pushpin may be used for attaching the heat sink module 106 to a connector component. In other examples, a locking tab, tongue-in-groove mechanism, or the link can be used for attaching the heat sink module 106 to a connector component.

During conduction of high levels of current between connector components 102 and 104, connector components 102 and 104 can generate high temperatures in one or both of connector components 102 and 104. Excessive heat at connector component 102 can be transferred to the heat sink module 106 for dissipation by the heat sink module 106. Further, for example, excessive heat at connector component 104 can be transferred to connector component 102, which can subsequently transfer to the heat sink module 106.

Now referring to FIG. 3, this figure illustrates a perspective view of connector component 102 and 104 and the heat sink module 106 operably attached together in accordance with embodiments of the present disclosure. Connector components 102 and 104 can each define flat or planar surfaces that touch when connector components 102 and 104 are attached together as shown in FIG. 3 to thereby facilitate electrical conduction and heat transfer between connector components 102 and 104. Connector components 102 and 104 can be connected together subsequent or prior to attachment of the heat sink module 106 to connector component 102.

In accordance with some embodiments, and with reference to FIG. 2, connector components 102 and 104 can be securely attached together by fitting a post 114 of connector component 102 into an aperture (not shown) formed in connector component 104. This secure connection can also facilitate electrical conduction and heat transfer between connector components 102 and 104. Alternatively, any other suitable technique or mechanism can be implemented for securely attaching and providing stability to the attachment of connector components 102 and 104. In example, connector components 102 and 104 can be attached together via friction, snaps, or threading them together.

It is noted that in this example the connector components 102 and 104 are cubical in shape; however, it should be understood that they may alternatively be of any suitable size and shape. Further, the heat sink module 106 may be of any suitable size and shape. The size and shape and connector components 102 and 104 and the heat sink module 106 can be suited to their particular intended use.

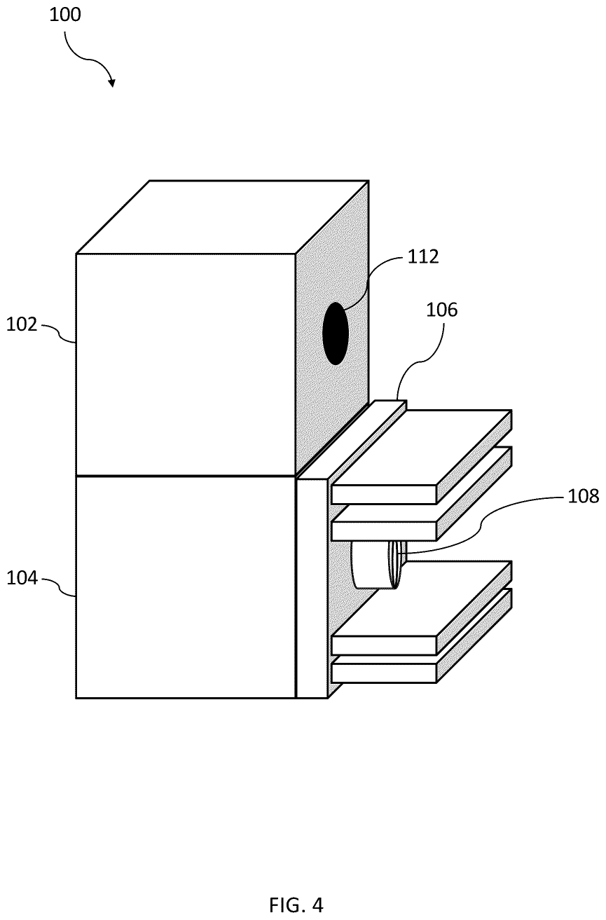

In embodiments, both connector components of an electrical connector system can be configured to be attached to a heat sink module. In this way, a heat sink module can be attached to either of the connector components, or two heat sink components can be attached to the connector components for providing more heat dissipation capabilities than the use of one heat sink module. As an example, connector component 104 shown in FIG. 1 includes a threaded hole (or heat sink attachment aperture) 116 that can be used for attachment of the heat sink module 106 to connector component 104 by the screw 108. For example, FIG. 4 illustrates a perspective view of the attachment of the heat sink module 106 to connector component 104, rather than connector component 102 as shown in FIG. 1. Depending on space constraints, the heat sink module 106 can be selectively attached to either connector component 102 or connector component 104 to meet limits of space around the electrical connector system 100.

FIG. 5 illustrates a perspective view of the heat sink module 106 and screw 108 being spaced apart. Referring to FIG. 5, the screw 108 include a head 502 and body 504. The head 502 can define a drive portion 506 where a tool (e.g., screwdriver) can engage the screw 108 for rotating the screw. The body 504 can include a shank and a threaded portion, although these are not shown for simplicity of illustration. The heat sink module 106 defines the aperture 500, which extends from one side of a base 508 to an opposing side of the base 508. The width of the aperture 500 is less than the width of the head 502 so that the head can hold the base 508 when the heat sink module 106 is attached to a connector component.

With continuing reference to FIG. 5, the heat sink module 106 includes multiple fins 510 for dissipating heat into surrounding air. During operation of an electrical connector system 100 for conducting current, heat can transfer from connector components 102 and/or 104 to the base 508, which transfers its heat to fins 510. The fins 510 can then transfer their heat to the surrounding air.

FIGS. 6A and 6B illustrate a front view and a side view of the heat sink module 106 in accordance with embodiments of the present disclosure. Referring to FIGS. 6A and 6B, the fins 510 are spaced apart such that air can flow therebetween. In this example, the heat sink module 106 includes four (4) fins 510, but it should be recognized that there can be any number of fins in any suitable arrangement. Further, the fins can be of any suitable size, shape, and orientation.

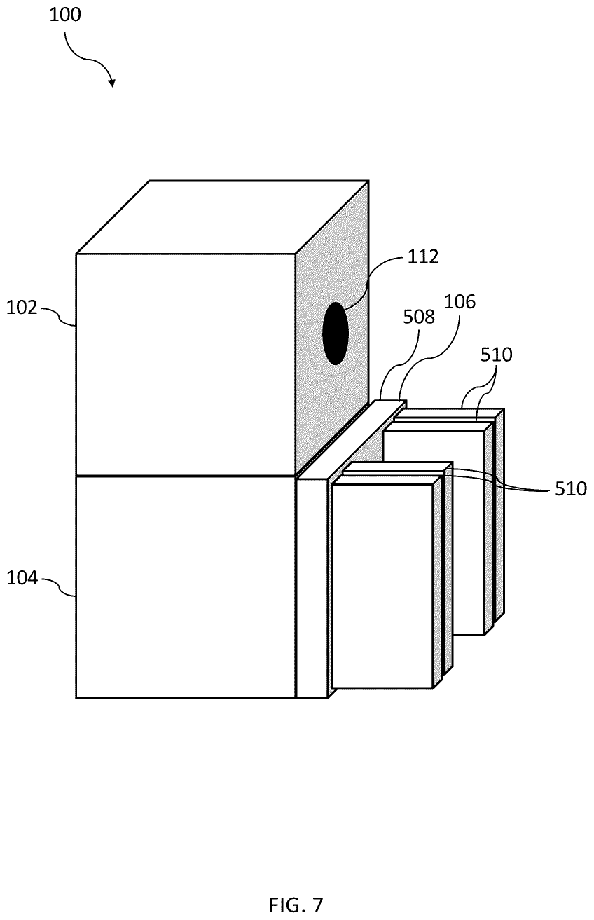

FIG. 7 illustrates a perspective view of the electrical connector system 100 with the heat sink module 106 oriented differently than its orientation in FIG. 4. In FIG. 4 the heat sink module 106 is oriented such that its fins extend in a horizontal direction, whereas in FIG. 7 the fins 510 extend vertically. The heat sink module 106 can be attached in different orientations due to space constraints. Also, the heat sink module 106 can be attached in different orientations according to expected air flow direction to maximize heat transfer to the flowing air. For example, if it is expected that most air flow would be in the horizontal direction, then the heat sink module 106 can be arranged as shown in FIG. 4. If it is expected that most air flow would be in the vertical direction, then the heat sink module 106 can be arranged as shown in FIG. 7. Also, depending on requirements (e.g., space requirements or expected air flow direction) the heat sink module 106 can be oriented at any suitable angle between the horizontal direction and the vertical direction of the fins 510 shown in FIGS. 4 and 7, respectively.

In some embodiments, a connector component may include more than one threaded hole. For example, a connector component may include a threaded hole on two or more of its sides such that a heat sink module can be selectively attached to any of the sides having a threaded hole. This provides increased flexibility for an installer to attach the heat sink module to meet a requirement such as a space limitation on a particular side of the connector component.

In some embodiments, an electrical connector system can have multiple different heat sink modules of different size and/or shape. In this way, the installer can suitably select one of the heat sink modules of an appropriate size and/or shape for meeting a space limitation.

Connector components 102, 104 and the heat sink module 106 can be made entirely or partially of any suitable material for facilitating heat transfer. For example, they can be made of metal, thermally conductive plastic, ceramic, and/or the like.

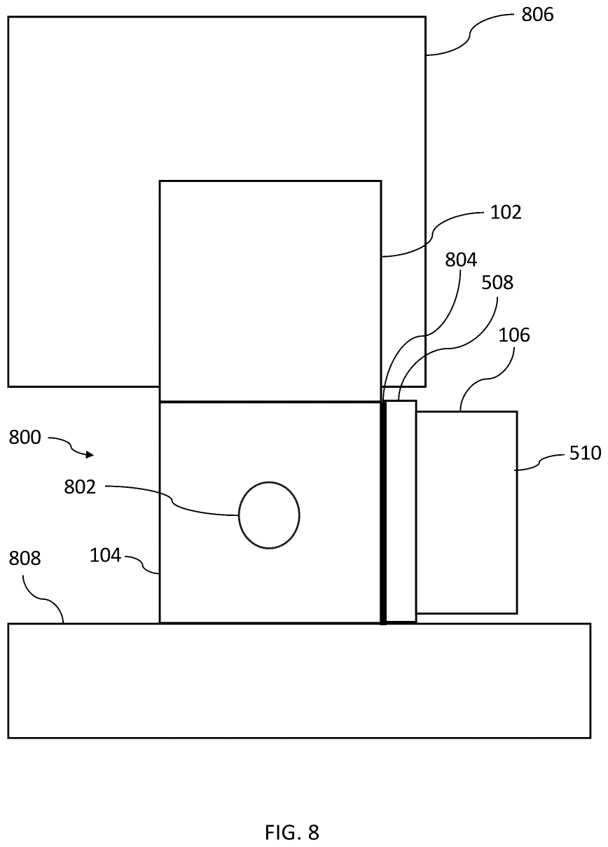

FIG. 8 illustrates a side view of another electrical connector system 800 in accordance with some embodiments of the present disclosure. Referring to FIG. 8, the system 800 is similar to the system 100 shown in FIG. 7 except that the system 100 also includes a second threaded hole 802 and a thermal interface material 804. The second threaded hole 802 is positioned at another side of the connector component 104 different than the side where the heat sink module 106 is attached in this figure. Thus, alternative to the depiction of attachment in FIG. 8, the heat sink module 106 can be selectively attached on a different side (i.e., the side with thread hole 802).

With continuing reference to FIG. 8, the thermal interface material 804 can be positioned between the connector component 104 and the heat sink module 106. The thermal interface material 804 can substantially cover the interface between the facing surfaces of the connector component 104 and the heat sink module 106 for facilitating heat transfer therebetween. In an example, the thermal interface material 804 can be grease, a thermal interface pad, and/or the like.

With continuing reference to FIG. 8, the figure shows the system 800 having operable connection to an expansion module or expansion card 806 and a computing device 808 for providing a conductive pathway between the expansion module 806 and the computing device 808. In this example, connector component 102 is operably connected to the expansion module 806, and connector component 104 is operably connected to the computing device (e.g., a server) 808. As an example, the connector component 102 may be attached to a card edge of the expansion module 806. Further, the connector component 104 may be operably connected to a main board or motherboard of the computing device 808.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. An electrical connector system comprising:
a first connector component that is electrically conductive and that includes a first conductive interface;
a second connector component that is electrically conductive and that includes a second conductive interface, wherein the first and second conductive interfaces are configured to operatively connect to each other; and
a heat sink module configured to removably attach to the second connector component and configured to transfer heat energy away from the second connector component.

2. The electrical connector system of claim 1, wherein the first connector component is configured for operable connection to an expansion module.

3. The electrical connector system of claim 1, wherein the second connector component is configured for operable connection to a main board of a computing device.

4. The electrical connector system of claim 1, wherein the first connector component defines a post for conductive connection to an aperture defined within the second connector component.

5. The electrical connector system of claim 1, wherein the heat sink module defines a plurality of fins on a side thereof.

6. The electrical connector system of claim 1, wherein the heat sink module is a first heat sink module, and
wherein the electrical connector system further comprises one or more other second heat sink modules having a different size and/or shape than the first heat sink module.

7. The electrical connector system of claim 1, wherein the first connector component, the second connector component, and the heat sink module are each made of metal, ceramic, or thermally conductive plastic.

8. The electrical connector system of claim 1, wherein the heat sink module defines an aperture for receipt of a screw or pushpin for attachment to the second connector component.

9. The electrical connector system of claim 1, further comprising a locking tab or tongue-in-groove mechanism for attachment of the heat sink module to the second connector component.

10. The electrical connector system of claim 1, wherein the heat sink module is configured to be oriented in different positions with respect to the second connector component when attached to the second connector component.

11. The electrical connector system of claim 1, wherein the second connector component comprises a plurality of sides configured for attachment of the second connector component.

12. The electrical connector system of claim 1, further comprising a thermal interface material positioned between the second connector component and the heat sink module when attached for facilitating heat energy transfer.

13. The electrical connector system of claim 1, wherein the thermal interface material comprises grease, a thermal interface pad, ceramic and/or thermally conductive plastic.

14. An electrical connector system comprising:
a first connector component that is electrically conductive and that includes a first conductive interface on a first surface of the first connector component and a first heat sink attachment aperture on a second surface of the first connector component;
a second connector component that is electrically conductive and that includes a second conductive interface on a first surface of the second connector component and a second heat sink attachment aperture on a second surface of the second connector component, wherein the first and second conductive interfaces are configured to operatively connect to each other; and
a heat sink module configured to removably attach to either the first connector component via the first heat sink attachment aperture or the second connector component via the second heat sink attachment aperture and configured to transfer heat energy away from the attached first or second connector component.

15. The electrical connector system of claim 14, wherein the first connector component defines a post for conductive connection to an electrical post aperture that is defined within the second connector component.

16. The electrical connector system of claim 14, wherein the heat sink module comprises plurality of fins on a side thereof.

17. The electrical connector system of claim 14, wherein the heat sink module is a first heat sink module, and
wherein the electrical connector system further comprises one or more other second heat sink modules having a different size and/or shape than the first heat sink module.

18. The electrical connector system of claim 14, wherein the first connector component, the second connector component, and the heat sink module are each made of metal, ceramic, or thermally conductive plastic.

19. The electrical connector system of claim 14, wherein the heat sink module is configured to be oriented in different positions with respect to the second connector component when attached to the second connector component.

20. The electrical connector system of claim 14, wherein the second connector component comprises a plurality of sides each configured for attachment of the heat sink module, the plurality of sides including the second side of the second conductor component.
